(19) United States
(12) Patent Application Publication
(10) Pub. No.: US 2004/0035647 A1
(43) Pub. Date: Feb. 26, 2004

(54) Elevator car frame with integral controller

(75) Inventors: Hideki Arai, Chiba-Ken (JP); Keiko Ozawa, Chiba-Ken (JP); Hideki Ito, Chiba-Ken (JP)

Correspondence Address: Thomas H. Osborn, 10 Farm Springs, Farmington, CT, 06032, US

(73) Assignee: Otis Elevator Company, Farmington, CT

(21) Appl. No.: 10/639,026

(22) Filed: Aug. 11, 2003

(30) Foreign Application Priority Data
Aug. 23, 2002 (JP) 2002-242852

(51) Int. Cl. B66B 11/02

(52) U.S. Cl. 187/401; 187/414

(57) ABSTRACT

A main body 17 of controller box 16 is attached to the lower surface of upper frame 15 of car frame 11 such that it can slide freely, and upper frame 15 is configured such that it constitutes a part of a wall of controller box 16.

### TECHNICAL FIELD OF THE INVENTION

The invention of the present patent application pertains to an elevator car to be hoisted and lowered by means of ropes.

### BACKGROUND OF THE INVENTION

As shown in FIGS. 6 and 7, car frame 2 in elevator cars is usually provided so as to surround car 1, and car 1 is supported by said car frame 2. Car frame 2 is configured with a lower frame, not illustrated, which supports the bottom surface of car 1, a pair of side frames 3 and 4 standing upright from either side of said lower frame, and upper frame 5 that joins said pair of side frames 3 and 4 together above car 1. In addition, controller box 7 is fixed to upper surface 6 of car 1, and a control panel (not illustrated) for controlling a motor that opens and closes the door is housed inside said box 7.

However, because controller box 7 must be fixed to the upper surface of car 1 after car frame 2 is assembled, and the constituents of car 1 are attached to said car frame 2, the conventional elevator car has the problem that the efficiency of assembly is poor due to the many steps required to assemble it at the construction site.

In addition, in conventional elevator cars, because controller box 7 must be placed where it does not interfere with upper frame 5 of car frame 2, not only is the layout of parts on top of car 1 difficult, but also it interferes with maintenance/inspection in that the space on upper surface 6 of car 2 where an operator climbs in during maintenance/inspection is restricted.

Thus, the invention of the present patent application aims to disclose an elevator car by which the efficiency of the controller box assembly operation can be improved, and the space on top of the car can be utilized effectively.

### SUMMARY OF INVENTION

The invention of the present patent application is configured such that the controller box is built into the upper frame while the upper frame constitutes a part of the wall of the controller box improving installation efficiency by eliminating the step for attaching the controller box to the upper surface of the car. Moreover, because there is no more need to provide space specifically for installing the controller box on the upper surface of the car, parts can be arranged on the upper surface of the car more flexibly, and standing room during maintenance/inspection can be provided.

In addition, because the upper frame constitutes a part of the wall of the controller box in the invention of the present patent application, the amount of metal plate material required for them can be reduced in order to reduce the material costs and overall weight.

Furthermore, because the controller box is built into the upper frame on top of the car in the invention of the present patent application, the position in which the upper frame is installed and the position of the overhead beam (the beam carrying the pulley that supports the hoisting rope) can be offset, so that a sufficient distance can be secured between the top of the car and the overhead beam when the car is hoisted to the top beam part. Therefore, where the same minimum distance as that in the prior art is to be provided, the height of the hoistway can most certainly be reduced, so that the hoistway can be made smaller.

### BRIEF DESCRIPTION OF DRAWINGS

FIG. 1 is an oblique view illustrating an embodiment of the subject invention.

FIG. 2 is an oblique view illustrating the installation arrangement of said embodiment.

FIG. 3 is a side view of said embodiment.

FIG. 4 is an oblique view illustrating another embodiment of the subject invention of the present patent application.

FIG. 5 is an exploded oblique view illustrating the installation arrangement for a third embodiment of the subject invention.

FIG. 6 is an oblique view of the prior art.

FIG. 7 is a side view illustrating said prior art.

### DETAILED DESCRIPTION OF THE PREFERRED EMBODIMENTS

As a means to solve the aforementioned problems, the invention of the present patent application is configured such that, in an elevator car which is configured with a car frame for supporting a car, a lower frame for supporting the bottom surface of the car, a pair of side frames standing upright from either side of said lower frame, and an upper frame for joining said pair of side frames together above the car, and which is provided with a controller box on top of the car that houses a control panel for controlling a motor, said controller box is built into the upper frame in order for the upper frame to constitute a part of a wall of the controller box.

With said invention, because the controller box can be built into the upper frame during the assembly of the car frame, the step for installing the controller box onto the top of the car is no longer needed. In addition, because the controller box is built into the upper frame, there is also no need to provide any special space on top of the car for installing the controller box.

The main body of the controller box on which the control panel is mounted may also be attached such that it can slide freely with respect to the upper frame. In such a case, the main body of the controller box can be pulled out of the upper frame easily by sliding it in order to inspect or replace the control panel. Thus, the ease of inspection/work can be improved by comparison to the situation in which the controller box is provided directly on the upper surface of the car.

In addition, it is desirable to provide the upper frame such that it is close to the part where the door of the car is opened and closed. In this case, the distance of the controller box from the door opening/closing part is reduced, so that they can be connected together without any connector part being required to be placed between them. Thus, because no junction box needs to be provided on the upper surface of the car in order to cover the connector part, the available space on top of the car is increased, so that the parts can be laid out more flexibly, and a wider standing area can be provided during inspection/work.

Moreover, it may also be configured such that a closed cross section is formed by the aforementioned upper frame and the main body of the controller box attached to said frame, and the aforementioned upper frame and the main body of the controller box are firmly joined together. In this case, because the upper frame forms a structure with a closed cross section when the main body of the controller box is connected to the upper frame to reinforce the strength, the upper frame can be reinforced without increasing the number of parts, and the shape of the upper frame itself can also be simplified. That is, a bumper is attached to the upper frame, and the load created by an upward thrust in the event of an emergency is absorbed by the upper frame via the bumper. The upper frame usually has a complicated cross-sectional shape in order to increase the strength to protect against the impact of an upward thrust. As described above, however, when the controller box is used to reinforce the upper frame, the complicated cross-sectional shape is no longer needed, so that a reduction in the manufacturing cost can be achieved through simplification of the shape.

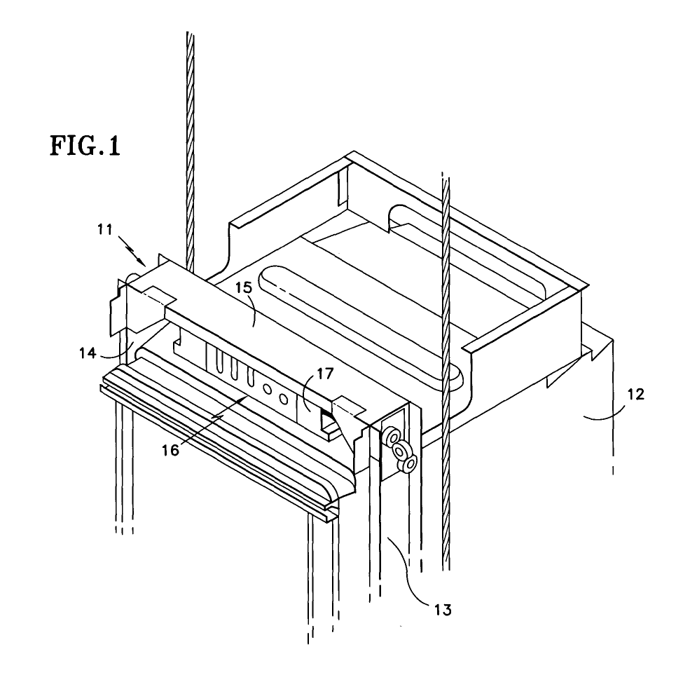

Next, an embodiment of the invention of the present patent application will be explained with reference to FIGS. 1-3.

In the elevator car of the present embodiment, car frame 11 is configured with a lower frame (beam), not illustrated, which is used to support the bottom surface (lower surface of the platform) of car 12, a pair of side frames 13 and 14 (uprights) standing upright from either side of said frame, and an upper frame 15 (crosshead) for joining side frames 13 and 14 together above car 12; and car 12 is provided with a door, not illustrated, which is provided on the front side and a door opening/closing mechanism, not illustrated, which includes a motor for opening/closing the door. In addition, car frame 11 is provided such that it is close to the door opening/closing part of car 12, and upper frame 15 is provided close to the door opening/closing mechanism.

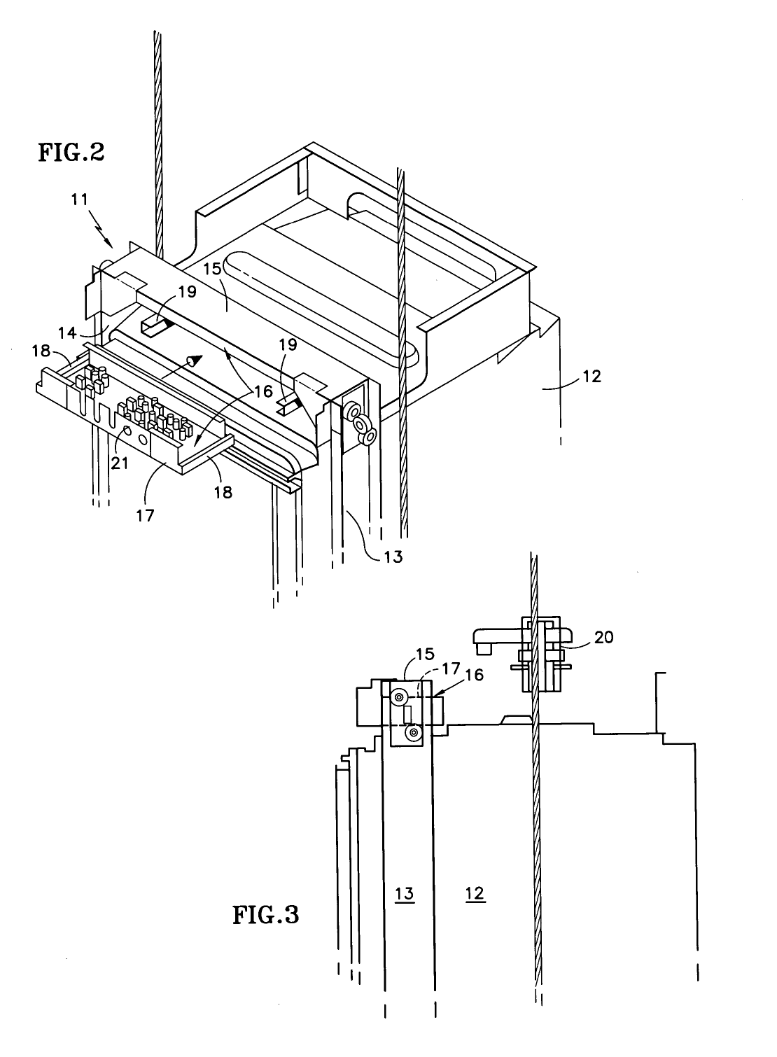

Upper frame 15 has a U-shaped cross section in which the basic cross section opens downward, and main body 17 of controller box 16 for housing control panel 21 (refer to FIG. 2) used to control the motor is attached roughly at the center in the length direction. Controller box 16 has a U-shaped cross section in which main body 17 opens upward, the top of main body 17 is covered by upper frame 15, and a box structure is created by main body 17 and upper frame 15.

In the present embodiment, as shown in FIG. 2, guide shoes 18 extending in the width direction are provided on either end of main body 17, and a pair of guide channels 19 for receiving said guide shoes 18 are attached to the lower surface of upper frame 15. Guide shoes 18 of main body 17 are then placed into corresponding guide channels 19 on upper frame 15 such that they can slide freely, in order to allow main body 17 to be opened and closed as it is slid from the front side of upper frame 15. In addition, a switch, not illustrated, which is closed when main body 17 is pulled out is provided between main body 17 and upper frame 15, and an emergency lamp, not illustrated, provided on top of car 12 is turned on as a result. This emergency lamp is used to illuminate an operator's footing during maintenance/inspection, so that the operation can not only be carried out more easily because the lamp is on, but also the safety of the work can be improved.

FIG. 3 is a schematic side view of the car and the upper part of the hoistway when the car is hoisted to the highest position. As shown in the figure, upper frame 15 and overhead beam 20 provided at the upper part of the hoistway are positioned such that they are offset with respect to each other in the front-to-back direction of the car. While overhead beam 20 is provided with a pulley for hanging a hoisting rope, a sufficient distance (separation greater than that required by law) is secured between beam 20, including said pulley, and the upper surface of car 12. Although in the past a controller box (7) was provided at the position immediately below said beam 20, as shown in FIG. 7, the absolute height of beam 20 can be reduced to the extent that controller box 16 is not placed in this position in the present embodiment. Therefore, when this structure is adopted the height of the hoistway in a building, such as in an ordinary house, can be kept low.

According to the structure described above, because controller box 16 and upper frame 15 of the car of the present embodiment are formed as a unit in order for upper frame 15 to constitute the upper wall of controller box 16, a reduction in the manufacturing cost and the weight can be achieved by reducing the metal plate material required for upper frame 15 and controller box 16, and the number of steps required for car assembly can be reduced, as will be described below.

That is, during assembly of the car, car frame 11 is installed first. At this time, main body 17 of controller box 16 is attached to upper frame 15 in advance. The constituents of car 12 are then attached to car frame 11, and the door and the door opening/closing mechanism are attached to the front side of car 12. Finally, the motor of the door opening/closing mechanism, and control panel 21 in controller box 15, are then connected using wiring cords. Therefore, during assembly of the car, the installation step that used to be performed to install controller box 16 onto the upper surface of car 12 after car 12 was installed is no longer needed, so that the assembly process is simplified to this extent.

In addition, because controller box 16 is built into upper frame 15 in the car assembled in this manner, a large space can be created on top of car 12. Thus, parts other than controller box 16 can be installed on the upper surface of car 12 more easily, and a large space can be secured for an operator to stand in during maintenance/inspection.

Furthermore, when upper frame 15 is provided such that it is close to the door opening/closing part, as it is the case in the present embodiment, the wiring between the control panel in controller box 16 and the motor of the door opening/closing mechanism is made shorter, so that control panel 21 in controller box 16 and the motor can be connected directly without any intervening connector. Therefore, no junction box for housing a connector needs to be provided on the upper surface of car 12, and the upper surface of car 12 can be more effectively utilized to this extent. Also, in addition to this effect, because the wiring between the control panel and the motor is made shorter, what is called unwanted radiation, that is, the generation of electromagnetic waves that affect devices inside and outside of the elevator, can be reduced. Therefore, there is no need to use shielded wires, which is used to be done for a household elevator as a means to block the unwanted radiation, so that the manufacturing cost can be reduced.

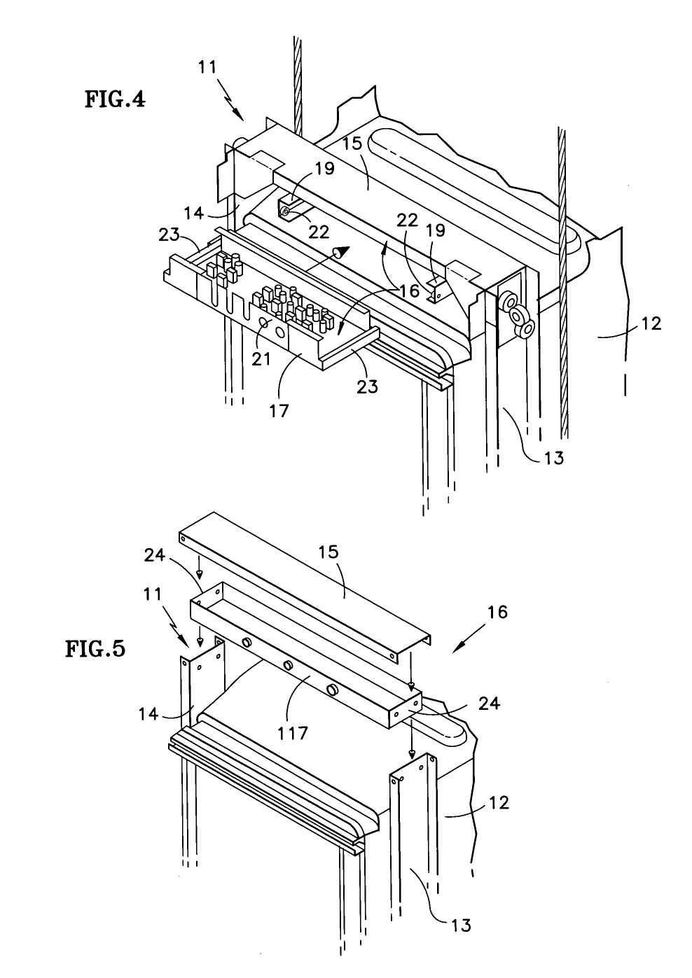

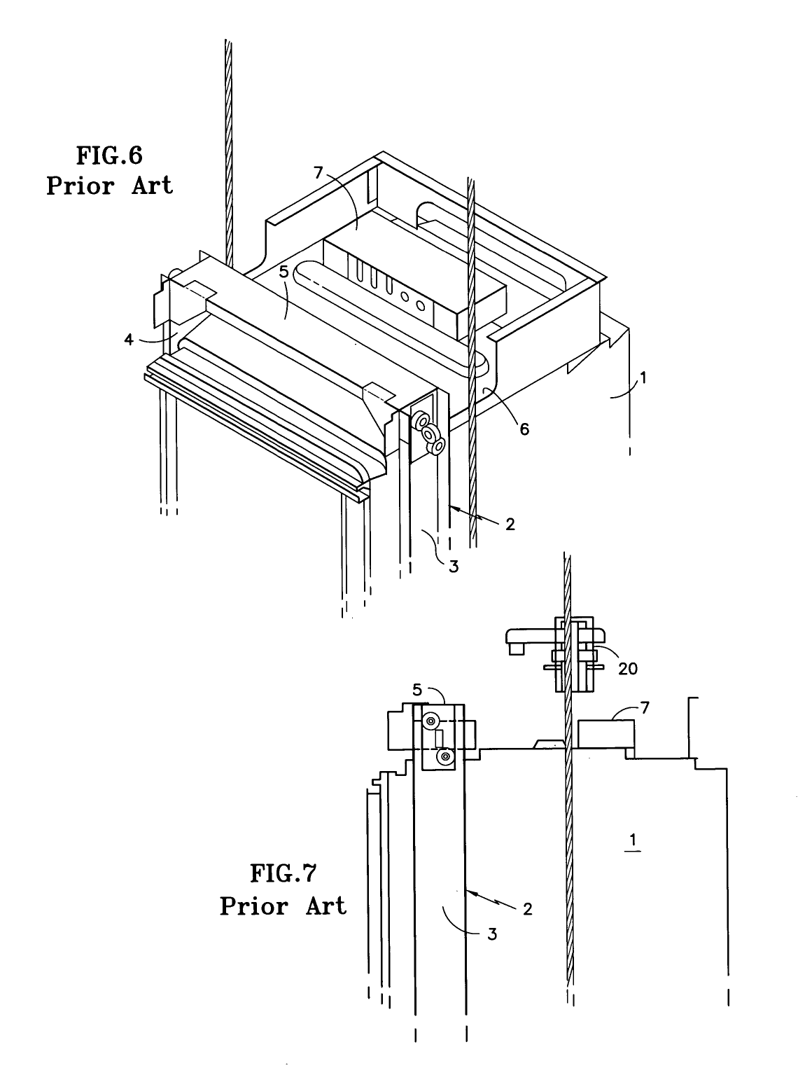

Although main body 17 of controller box 16 was provided with guide shoes 18, and said guide shoes 18 were slid into guide channels 19 provided on the upper frame 15 above, rollers 22 may be provided inside guide shoes 19, as shown in FIG. 4, in order to allow guide pieces 23 on the ends of main body 17 to be guided freely as said rollers 22 rotate. This allows main body 17 to be opened and closed more easily, so that maintenance/inspection can be carried out more easily.

In addition, FIG. 5 shows another embodiment in which main body 117 of controller box 16 is attached to the lower surface of upper frame 15 without any intervening sliding mechanism. In the case of the present embodiment, main body 117 of controller box 16 has a length almost equal to the distance between side frames 13 and 14, and end walls 24 on either side of main body 117 are bolted to the upper ends of side frames 13 and 14.

While almost the same effects as those provided by the aforementioned embodiment can also be achieved with the present embodiment, main body 117 can be removed from the lower surface of upper frame 15 by removing the bolts used to attach main body 117 to frames 13 and 14 during inspection/maintenance of the control panel.

Furthermore, in the present embodiment, when main body 117 and upper frame 15 are joined together firmly by bolting main body 117 of controller box 16 to upper frame 15, upper frame 15 has a completely closed cross-sectional structure (a box structure), so that upper frame 15, which needs to be strong, can be further reinforced without increasing the number of parts or complicating the cross-sectional shape. That is, because upper frame 15 needs to absorb the impact caused by an intense upward thrust in the event of an emergency, it has to be reinforced using additional members, and the cross-sectional shape must be carefully thought out. However, when the aforementioned configuration is adopted, the strength of upper frame 15 can be increased easily without the necessity of such special countermeasures.

In addition, although an example in which main body 117 of controller box 16 was attached to the lower surface of upper frame 15 was explained above, main body 117 of controller box 16 may also be attached to the upper surface of upper frame 15. However, when main body 17 (117) of controller box 16 is attached to the lower surface of upper frame 15, as in said respective embodiments, the top side (top side of the control panel) of main body 117 can be completely covered by upper frame 15 serving as a reinforcing member, so that the problem of a damage to the control panel in the event of a heavy impact from above can be reliably prevented.

Variations and modifications to the disclosed examples may become apparent to those skilled in the art that do not necessarily depart from the purview and spirit of this invention. The scope of legal protection given to this invention can only be determined by studying the following claims.

We claim:

1. An elevator car frame including a lower frame for supporting the bottom surface of an elevator car, a pair of side frames standing upright from either side of said lower frame, and an upper frame for joining together said pair of side frames above the car, the elevator car frame comprising:
a controller box built into the upper frame wherein the upper frame forms part of the controller box.

2. The elevator car frame according to claim 1, the controller box further comprising a means for releasably mounting a control panel with respect to the upper frame.

3. The elevator car frame according to claim 2,the means for releasably mounting comprising a slide mechanism.

4. The elevator car frame according to in claims 1 through 3 wherein said elevator car frame is located proximate the front of the car.

5. The elevator car frame according to claim 1, the controller box comprising:
an upper surface formed by the upper frame; and,
a main body attached to the upper frame.
